(19) United States
(12) Patent Application Publication
(10) Pub. No.: US 2016/0310902 A1
(43) Pub. Date: Oct. 27, 2016

(54) ELECTRODIALYSIS SPACER AND STACK

(71) Applicant: General Electric Company, Schenectady, NY (US)

(72) Inventors: Vinay Sonu SAWANT, Singapore (SG); John H. BARBER, Guelph (CA); Harikrishnan RAMANAN, Singapore (SG); Varshneya SRIDHARAN, Singapore (SG)

(21) Appl. No.: 15/106,282

(22) PCT Filed: Aug. 20, 2014
(86) PCT No.: PCT/US2014/051881

§ 371 Date: Jun. 18, 2016

Related U.S. Application Data
(60) Provisional application No. 61/918,717, filed on Dec. 20, 2013.

(51) Int. Cl. B01D 61/50; B01D 65/10; B01D 63/08; B01D 61/52; B01D 61/42

(52) U.S. Cl. CPC B01D 61/50; B01D 61/52; B01D 61/422; B01D 63/082; B01D 65/104; B01D 2313/02; B01D 2313/04; B01D 2313/14; B01D 2313/13

(57) ABSTRACT

A spacer for a membrane stack has an upper surface and a lower surface. The upper surface has a raised perimeter surrounding a membrane supporting section. The spacer has one or more protrusions and recesses configured such that the one or more protrusions of a first spacer fit into one or more recesses of a second spacer with the same protrusions and recesses stacked against the first spacer. Optionally, there may be an interference or snap fit. In a stack, membranes are placed on the membrane supporting sections located between spacers. In one embodiment, the bottom of an upper spacer rests on the raised perimeter of a lower spacer. A spacer may have a hole extending from an edge of the spacer to the interior of a flow field within the spacer. The hole allows access to the flow field for diagnostic testing and/or sampling.

### CROSS-REFERENCE TO RELATED APPLICATIONS

This application is a national stage application under 35 U.S.C. §371(c) of prior filed, co-pending PCT application serial number PCT/US2014/051881, filed on Aug. 20, 2014 which claims priority to U.S. Provisional Application No. 61/918,717 filed Dec. 20, 2013. The above-listed applications are herein, incorporated by reference.

### FIELD

This specification relates to membrane stacks, for example as used in electrodialysis or other electrically driven membrane separation devices, and to methods of making them.

### BACKGROUND

In typical plate and frame type electrically driven membrane separation devices, a stack is built up of alternating ion exchange membranes and spacers. The spacers electrically insulate the ion exchange membranes from each other and provide flow channels between them. Gaskets are provided between the spacers and the membranes around the flow channels. In an electrodialysis (ED) stack, including ED variants such as electrodialysis reversal (EDR) and reverse electrodialysis (RED), the ion exchange membranes alternate between anion and cation exchange membranes. In other types of stacks (Donnan or Diffusion Dialysis) there may be only cation exchange membranes or only anion exchange membranes. In electro-deionization (EDI) or continuous electrodialyis (CEDI) stacks there are alternating anion and cation exchange membranes and ion exchange resin in the flow channels of some or all of the spacers. In a further extension the ion exchange membranes in the ED stack may be replaced with high surface area electrodes producing a capacitive deionization stack.

U.S. Pat. No. 6,235,166 describes an electrically driven membrane apparatus having a spacer having a perimeter having a surface with an inner peripheral edge defining an opening, and a recess formed on the inner peripheral edge, and an ion exchange membrane having an outer edge fitted within the recess. A stack includes two types of spacers. One type of spacer has a seal member and is made of relatively soft material. The other type of spacer is made of relatively hard material and has a groove to accept the seal member of the other type of spacer.

### BRIEF DESCRIPTION

The following introduction is intended to introduce the reader to the detailed description to follow and not to limit or define the claims.

Spacers between membranes in electro-separation systems represent the flow paths of a de-mineralized (alternatively called feed or dilute) stream and a concentrate (alternatively called the brine stream) stream. These spacers are typically made of low density polyethylene or similar material and are arranged in the membrane stack so that all of the demineralized streams are hydraulically grouped together and all the concentrate streams are grouped together. A repeating section called a cell pair is formed consisting of a cation exchange membrane, demineralized water flow spacer, anion transfer membrane and concentrate water flow spacer. This specification describes a new design for spacers and cell pairs and methods for defining flow areas against membranes and compartmentalizing cell pairs. The designs and methods are useful, for example, for dialysis and electrodialysis including variants such as electrodialysis reversal, reverse electrodialysis, donnan dialysis and electro-deionization.

This specification describes a spacer having an upper surface and a lower surface. The upper surface has a raised perimeter surrounding a membrane supporting section. The spacer has one or more protrusions and one or more recesses outside of the membrane supporting section. The raised perimeter may be, or may include, a protrusion or recess. The protrusions and recesses are configured such that the one or more protrusions of a first spacer fit into one or more recesses of a second spacer with the same protrusions and recesses stacked against the first spacer to form a water seal. Optionally, there may be an interference or snap fit between a recess and a protrusion. A stack may be made by placing a plurality of spacers one on top of each other with membranes placed on the membrane supporting sections located between spacers. In an embodiment, the bottom of an upper spacer rests on the raised perimeter of a lower spacer. Optionally, additional sealing materials may be provided with the spacers, in separate gaskets, or injected into the stack.

This specification also describes a spacer having at least one hole extending from an edge of the spacer to an interior of a flow field within the spacer. This hole may be used, for example, to extract a water sample from the flow filed or to insert a probe, sensor or imaging device into the flow filed. The hole may be plugged when not being used or may be attached to a sampling port through a valve.

### BRIEF DESCRIPTION OF THE FIGURES

FIG. 1 shows a schematic cross section of an electrodialyis stack.

FIG. 2A shows a top view of a flat spacer.

FIG. 2B shows a side view of the flat spacer.

FIG. 3 is a conceptual edge view drawing of a first spacer with a raised perimeter and cooperating protrusions and recesses.

FIG. 4 is a conceptual isometric view of the spacer of FIG. 3.

FIG. 5A is an isometric view of a second spacer with a raised perimeter and cooperating protrusions and recesses.

FIG. 5B is an isometric view of a third spacer with a raised perimeter and cooperating protrusions and recesses.

FIGS. 6A-1 and 6A-2 are enlarged views of parts of the spacer of FIG. 5A.

FIGS. 6B-1 and 6B-2 are enlarged views of parts of the spacer of FIG. 5B.

FIG. 7 is an isometric exploded view of an assembly of three of the spacers of FIG. 5A and three membranes.

FIG. 8 is an enlarged view of a pluggable hole in a spacer of FIG. 5A.

FIG. 9 shows a plan view of a 90 degree rotatable spacer.

FIG. 10 shows a plan view of a 180 degree rotatable spacer.

FIGS. 11 and 12 show plan and side views of an alternative spacer with a finger-like sealing surface.

FIGS. 13 and 14 show plan and side views of an alternative spacer having a rib form sealing surface.

FIG. 15 shows an alternative spacer with a lateral or horizontal snap fit.

### DETAILED DESCRIPTION

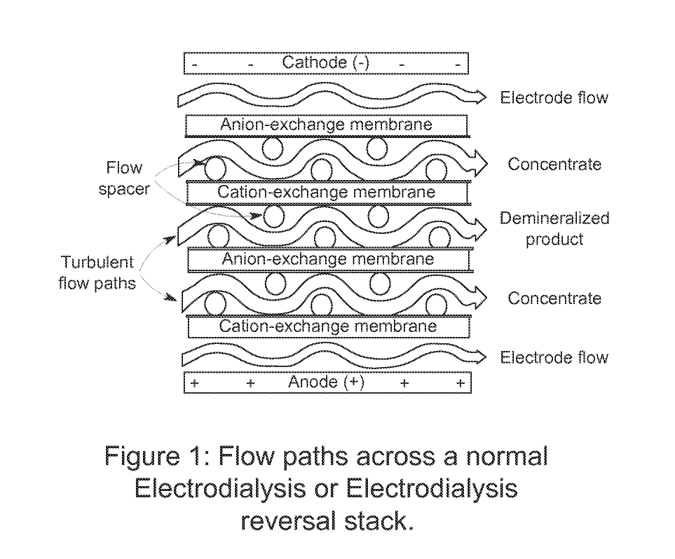

FIG. 1 shows an electrodialysis stack. An anode and a cathode are separated by a series of anion exchange membranes and cation exchange membranes. In the stack shown, the anion and cation exchange membranes alternate. In other examples of electrodialysis or other stacks, there may be places in which two of the same membrane type are used in succession or the entire stack may have one type of membrane. Various liquids flow between the membranes. These flows typically occur through spacers, which have cross straps to do one or more of give the spacer physical integrity, support the adjacent membranes, aid stack alignment during assembly and to promote turbulence which helps reduce colloidal deposition. The spacers physically separate and insulate successive membranes. The spacers are typically about 0.1 mm to 10 mm thick. The spacers may also provide structure within a flow field to define a flow path from an inlet to an outlet between two membranes.

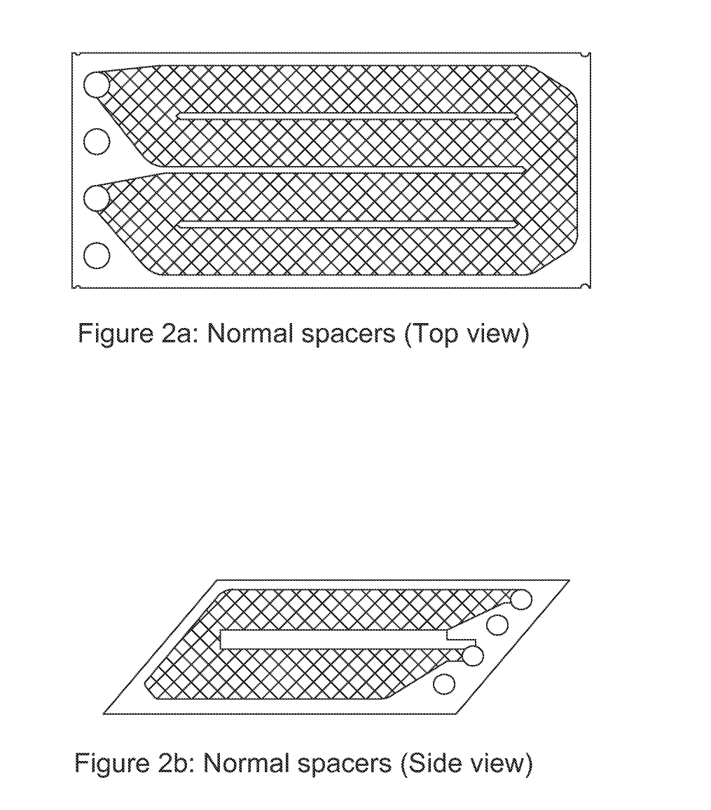

FIG. 2 shows a flat spacer. The spacer has two pairs of ports. In a stack, the ports and corresponding manifold cutouts in the membranes form vertical pipes in the stack. One pair of ports provides an inlet and outlet to a flow field. The other pair of ports completes internal conduits which will be used to supply or remove fluid from adjacent spacers. The adjacent spacers which will be inverted relative to the spacer shown or have its flow field connected to the other two ports. The area outside of the flow field and ports is essentially flat. In a stack, a membrane having the same outer dimensions as the spacer is placed between each pair of spacers. After any other elements, for example electrodes or end plates, are added, the stack is compressed. While this may produce a usable stack, it is difficult to keep the stack aligned while it is being assembled. Further, the edges of the membranes are exposed at the sides of the stack. There may be leakage through the membranes themselves or between the membranes and the spacers to the outside of the stack. The external stack surfaces may become wavy or crusted with scales. Further, the membrane edges may dry out and deteriorate.

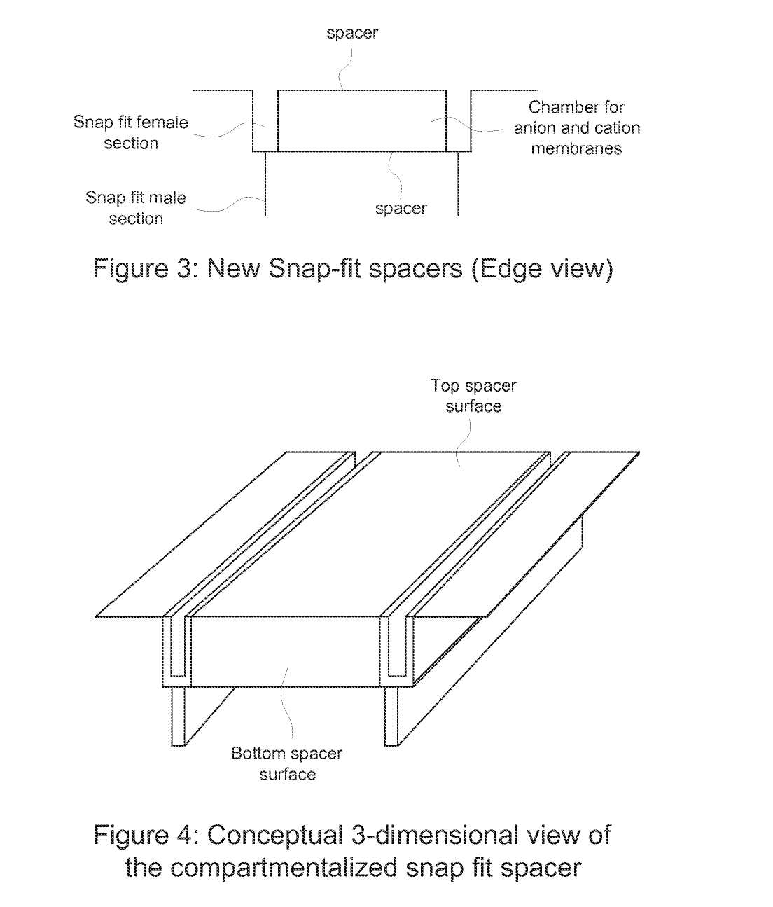

FIGS. 3 and 4 show a first spacer with a raised perimeter and co-operating protrusions and recesses. In this spacer, there is a raised perimeter in the form of a U-shaped slot extending along two sides of the spacer and a ridge of the same height extending between the U-shaped slots on the remaining two sides of the spacer. The U-shaped slots and ridges together surround a membrane supporting section of the spacer. The ridge extending across the front of the spacer has been removed from FIG. 3 to show the inside of the membrane supporting section. The slot optionally provides a snap fit female section. A snap fit male section extends downwards from the spacer below the snap fit female section. When another identical spacer is placed on top of the spacer shown, a chamber is formed between the membrane supporting sections of the upper and lower spacers and the raised perimeter of the lower spacer, optionally in combination with one or more protrusions from the upper spacer. The chamber compartmentalizes a membrane placed on the membrane supporting section. This helps prevent leaks to the outside of a stack. The snap fittings also help keep portions of a stack together while more spacers are added which makes assembling the stack easier. The raised perimeter also helps to stiffen the spacer. In an embodiment, the spacer also has one or more ports to enable diagnostic testing of cell pairs in a stack without dismantling the stack. Alternatively, the snap fit members may be replaced with members having a vertical sliding fit that provides lateral interference, which may allow for a wider range of membrane thicknesses to be used in the stack. Alternatively, one or both of the co-operating protrusions and recesses may be made of, or include, a flexible or elastomeric material that helps form a seal when compressed.

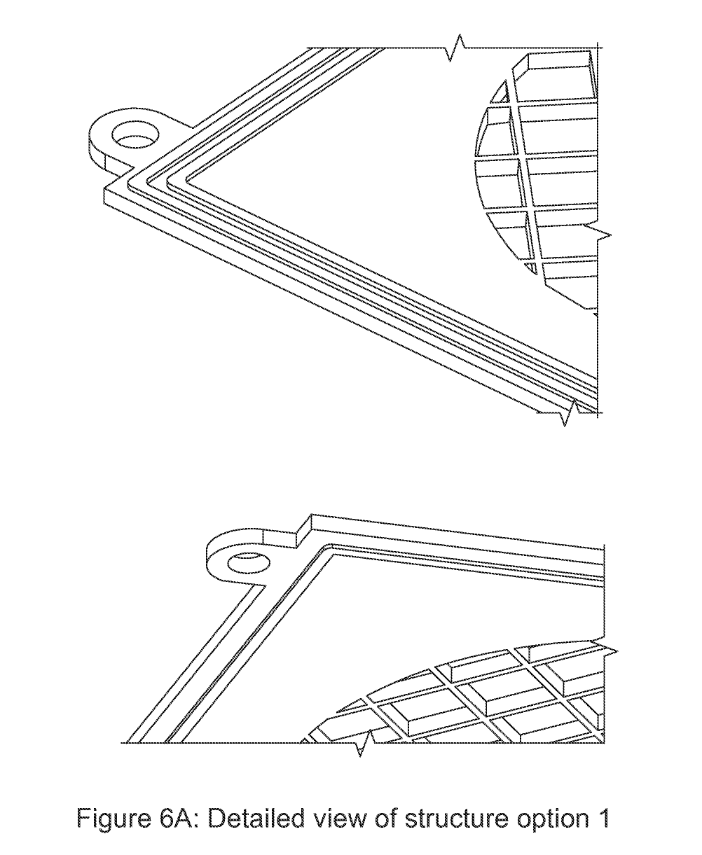

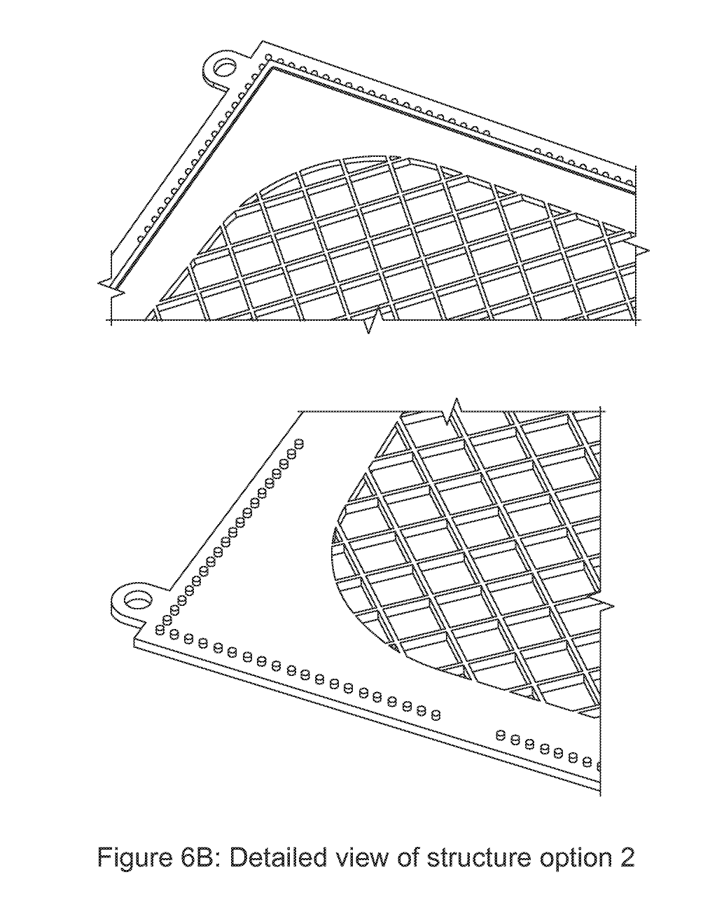

FIGS. 5A, 6A-1, 6A-2, 7 and 8 show a second spacer with a raised perimeter and cooperating protrusions and recesses. This spacer also has a raised perimeter in the form of a U-shaped slot surrounding a membrane supporting section. The first spacer has two pairs of ports. One pair of ports provides an inlet and outlet to a flow field. The other pair of ports completes internal conduits which will be used to supply or remove fluid from adjacent spacers, which will have an inverted membrane supporting section relative to the spacer shown. The flow in the flow field of one spacer is parallel to flow in an adjacent flow field although the direction of flow may, optionally, be reversed in alternating spacers. The area between the flow field and ports and the raised perimeter is essentially flat.

In an embodiment, the flow field has diagonal bars (as shown) or other turbulence promoting structures. The diagonal bars are shown extending through the thickness of the membrane supporting section only to simplify the drawing. When made, the diagonal bars extending in one direction will extend through only the top half of this thickness and the diagonal bars extending in the other direction will extend only through the bottom half of this thickness. Alternatively, there may be a woven mesh or inner portions of the diagonal bars are removed between intersections between diagonal bars to provide openings for water to flow through the bars. One or more spacer lands, however, may extend through the entire thickness of the membrane supporting section to promote a more nearly even distribution of flow through the flow field. In an embodiment, the diagonal bars are configured to support membranes of varying mechanical strengths.

Alignment holes outside of the raised perimeter, optionally located in tabs as shown, can be used to slide the spacers down rods in an assembly jig to help align the spacers while assembling a stack.

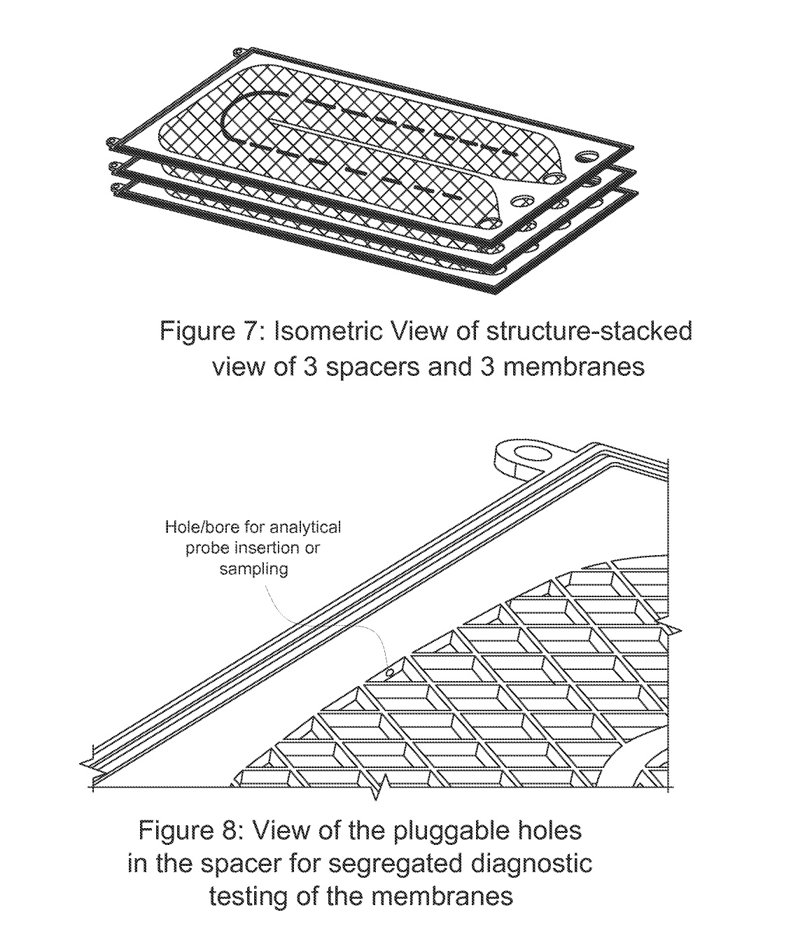

Referring in particular to FIG. 6A-1 and FIG. 6A-2, there is a U-shaped slot extending upwards from the top of the spacer. A ridge extending downwards from the bottom of the spacer has an outside thickness that corresponds with the inside width of the slot. The ridge is also vertically aligned with the inside of the slot. In this way, the spacer shown can be placed on top of another spacer with a similar slot and ridge with the ridge of the spacer shown sliding into the slot of the other spacer. Similarly, another spacer can be placed on top of the spacer shown with the ridge of the upper spacer sliding into the slot of the spacer shown. A membrane is placed inside of the slot of each lower spacer before an upper spacer is added. The resulting structure is shown in exploded view in FIG. 7. Further spacers can be added to make a stack of a desired size. Optionally, a stack can be assembled with the ridge extending upwards and the walls of the slot extending downwards. In an embodiment, the ridge fits closely to at least the inside wall of the slot such that there is a laterally interfering fit between them. Optionally, there may be a snap fit between the ridge and the slot. Optionally, the alignment holes and U-shaped slots can be designed outside the raised perimeter laterally parallel to the spacer plane as opposed to the vertical arrangement, for example the snap fit can happen in the horizontal plane.

FIGS. 5B, 6B-1 and 6B-2 show a third spacer. This spacer has a raised perimeter around in the form of a raised ridge or wall surrounding the membrane supporting area. Outside of this wall, there is a plurality of circular holes. On the bottom of the spacer, there is a plurality of cylinders. The cylinders are located and size to slide, or optionally snap fit, into the circular holes of another spacer when multiple spacers are stacked together. Optionally, the cylinders may be located on the side of the spacer with the raised wall and the circular holes may be located on the other side. Optionally, the circular holes and cylinders may be replaced with recesses and protrusions of other compatible shapes. Optionally, the recesses and protrusions can be designed laterally parallel to the spacer plane as opposed to the vertical arrangement.

FIG. 8 shows a hole through one edge of the second spacer. Optionally, additional holes may be provided through the same or a different edge. A valve, instrument fitting, or removable plug (not shown) may be fitted into to hole. Similar holes may be provided in the first or third spacer. The holes allow for sampling water in the flow field of for inserting an analytical probe in communication with the flow field. These edge holes allow for segregated diagnostic testing of individual cells in the stack. Diagnostic testing may include, for example, probe based measurements, leak testing, or scale or foulant material sample. A test may analyze conditions in a flow field. An analysis of conditions in the flow field on either side of a membrane can be used to determine properties of the membrane. An analysis of conditions in flow fields that are spaced further from each other can be used to determine if conditions vary across the stack. If a problem is detected in a particular part of the stack, the stack can be opened at the problem without dis-assembling the rest of the stack. Optionally, one or more edge holes may be used to allow for real time or remote monitoring of process or stack conditions.

A spacer may be made, for example, from low density polyethylene or a similar material.

The designs described above at least provide useful alternative structures for making membrane stacks. In addition, the spacer or cell design helps prevent external leaks from the stack and allow for compartmentalizing the membrane within the spacer. In a conventional stack, the membrane edges are exposed. There is often leakage from the membrane edges which become dry and crusted with scale. In addition, the membrane edge dryness can cause polymer to fall off and cloth threads to be exposed, which could reduce the performance of the stack over time. The spacer described above encloses the membranes, which keeps them moist and helps prevent external leaks. Further, each membrane is seated on the bottom of a spacer while liquid flows over the membrane within a compartment or chamber surrounded by the raised perimeter of the spacer. The spacers also provide good structural support for the membranes and may be used with membranes of varying thickness, for example between 0.1 mm and 2 mm thick and varying strength.

A conventional stack can also be difficult to assemble with the stack elements properly aligned. The spacer structure described assists with alignment since the snap fitting parts are optionally self-aligning and each previously snap fit section remains aligned while new parts are added. The two alignment holes also facilitate stack adjustment before snap fitting.

A conventional stack sometimes must also be dismantled to diagnose problems with the stack. The spacer and cell design described above allows a technician to investigate specific parts of the stack without dismantling it. Ports allow for diagnostic tests to be performed in particular chamber without dismantling the stack. The ports may also be used to install instruments or sensors for remote monitoring of the stack. The snap fit design then allows a defective membrane compartment to be opened while other compartments remain closed.

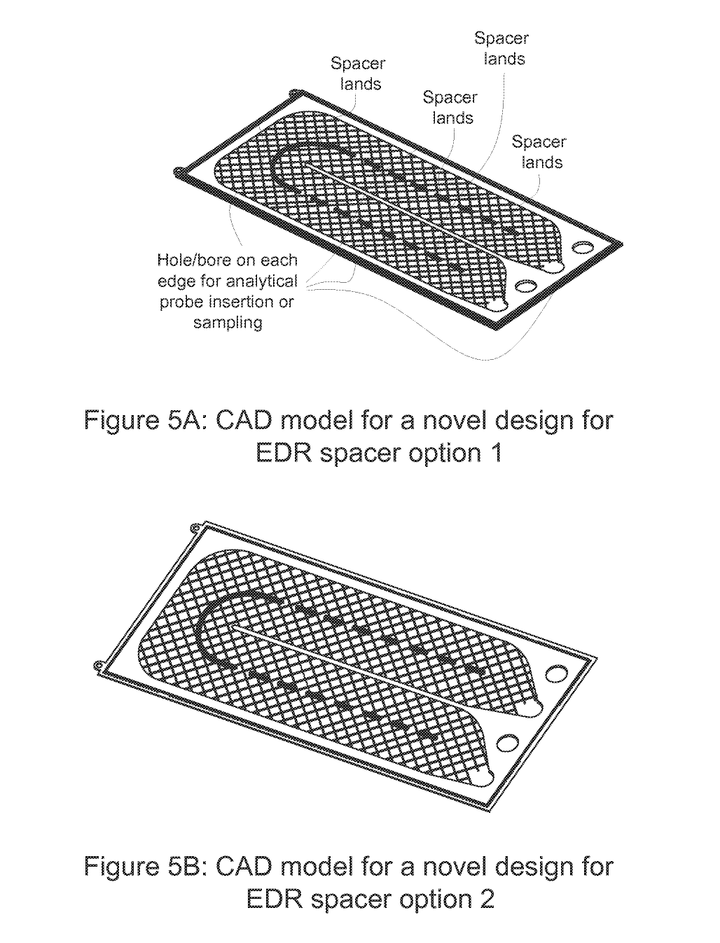

As shown in FIG. 5A, the spacer may also have a snap fit design to the spacer baffles section. This enables spacers to be piled up one on top of the other snugly with membranes in between them. This design does require the membranes to have suitable gap-hole so as to facilitate the snap fitting of adjacent spacers.

In some existing stacks with conventional spacers, there is only one type of spacer, which may be flipped along its length to form dilute and concentrate chambers. The spacers described above generally cannot be flipped in this way while preserving the sealing features. Therefore, two types of spacers are made, one to form dilute chambers and one to form concentrate chambers. Optionally, these two types of spacers may be color coded or otherwise marked to reduce the chances of mixing them up.

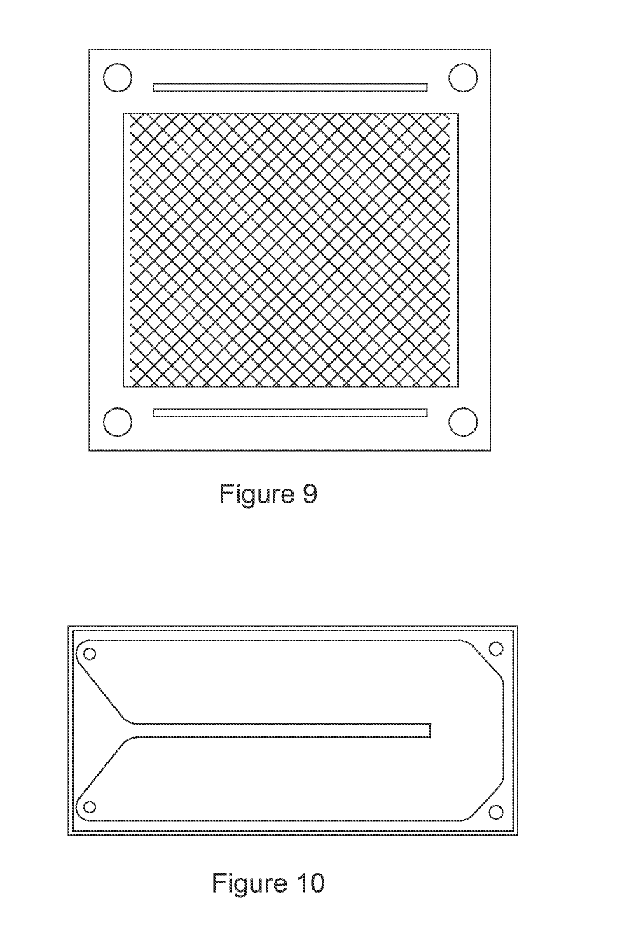

Alternatively, a spacer may be made that can be rotated to produce dilute and concentrate chambers. FIG. 9, for example, shows a square spacer. If the diagonally opposed ports are used to form internal pipes connected to one type of chamber, then rotating the spacer by 90 degrees produces alternatively dilute and concentrate chambers. If two ports on one side are used to form internal pipes connected to one type of chamber, then rotating the spacer by 180 degrees produces alternatively dilute and concentrate chambers. A raised perimeter and co-operating protrusions and recesses, for example a snap fitting feature, is not shown in FIG. 9, but can be added running around the perimeter of the spacer with the co-operating protrusions and recesses located one on the bottom and one on the top of the spacer. FIG. 10 shows a rectangular spacer. The two ports on one short side are used to form internal pipes connected to one type of chamber. Rotating this spacer by 180 degrees produces alternatively dilute and concentrate chambers. A raised perimeter and co-operating protrusions and recesses, optionally a snap fit feature, is provided around the border of the spacer.

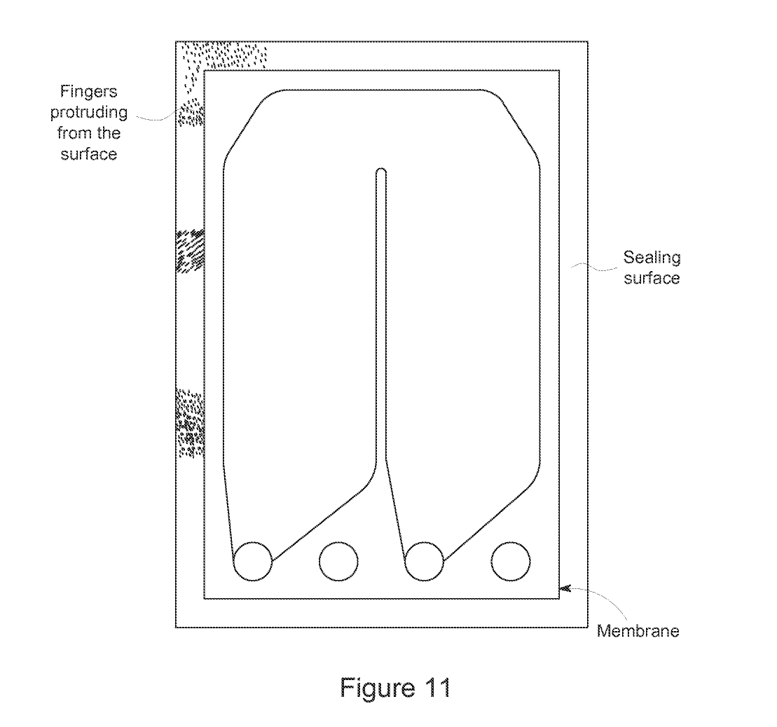

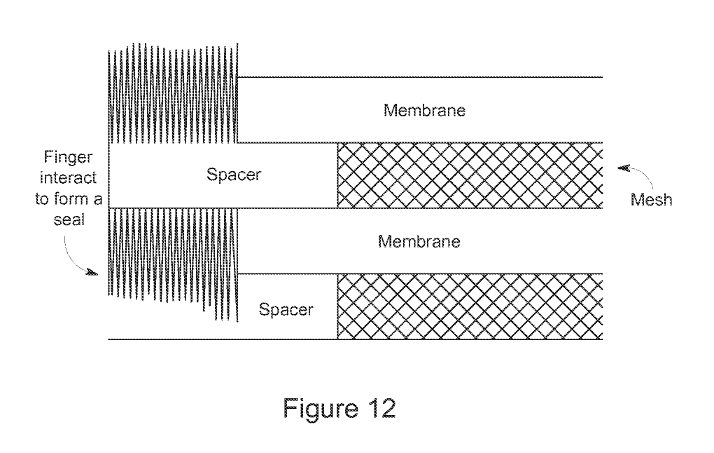

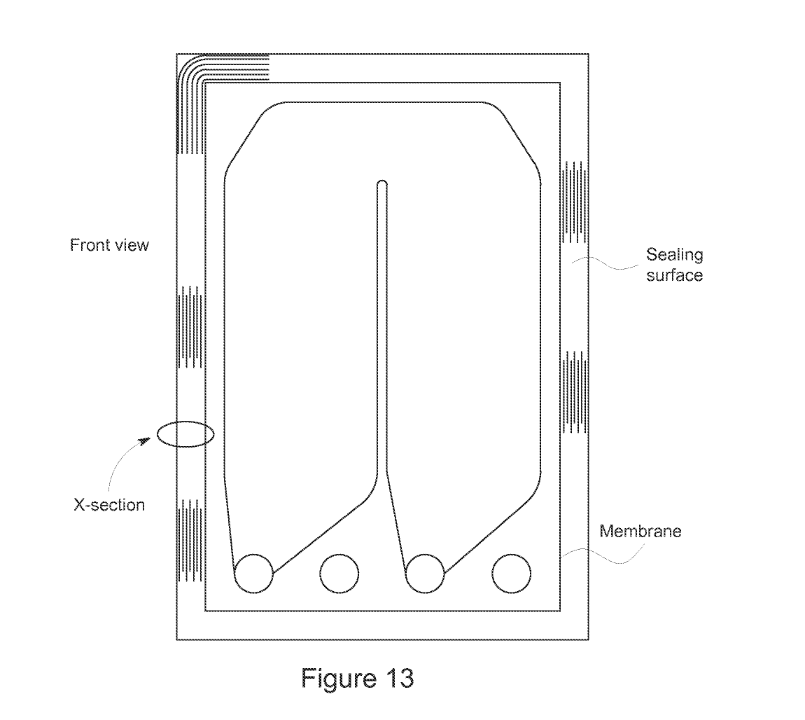

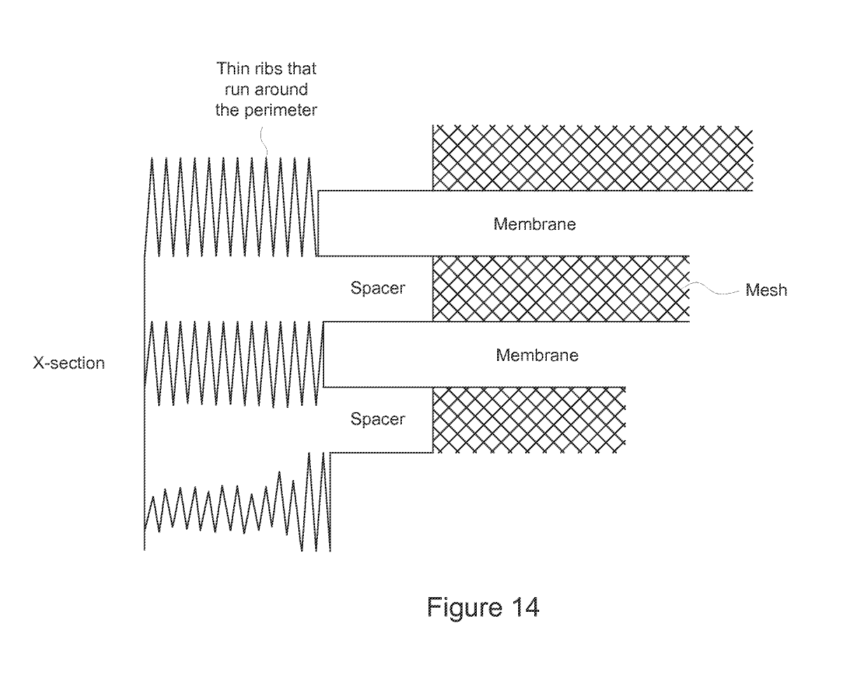

In another alternative, a seal is formed by the interaction of multiple flexible elements rather than a snap fit. For example, as shown in FIGS. 11 and 12, a seal is created by many small fingers protruding in one or both directions from the plane of the spacer. In FIGS. 13 and 14, a seal is made by a series of ribs that run around a perimeter of the spacer. These ribs may also protrude in one or both directions from the plane of the spacer. In either case, there are many small and fine features (i.e. the ribs or fingers) that can form a seal whether they interfere with each other or not. With these features protruding in one direction, as shown in FIGS. 12 and 14, a seal is produced by contact between the features of one spacer and the bottom of another spacer. The features do not require registry to one another or fine tolerances to make a seal. With the features protruding in both directions from the spacer, optionally to less of a height than what is shown in FIGS. 12 and 14, the spacer could also be flipped to form alternatively dilute or concentrate chambers.

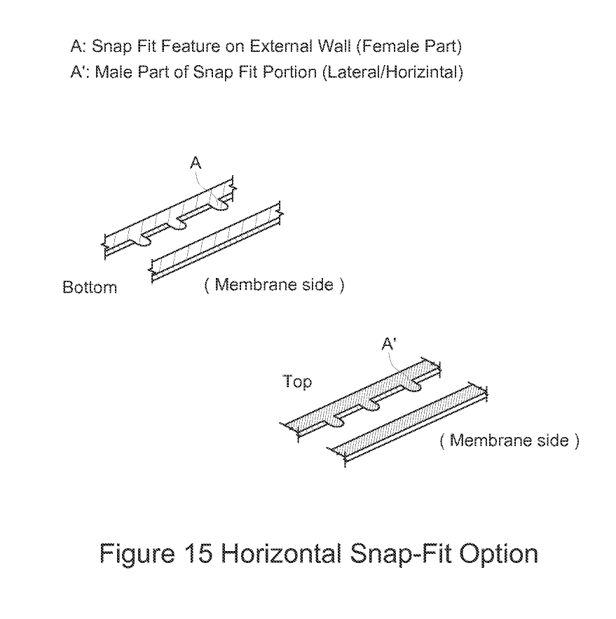

In another alternative, co-operating protrusions and recesses are provided on the external edges or walls of a spacer as shown in FIG. 15. Optionally, a raised perimeter may be provided inside of the co-operating protrusions and recesses. Optionally, a horizontal or lateral snap fit is provided. For example, there may be a series of protrusions extending out from one side of the plane of the spacer and spaced around the perimeter of the spacer. These protrusions fit into corresponding recesses spaced around the peripheral edge of the spacer. Optionally, the snap fitting features may be provided only on one edge of the spacer, or on two opposed edges of the spacer but with the protrusions on the opposed edges protruding in opposite directions, and the snap fit may be made by a horizontal movement of sliding a spacer onto the top of a stack rather than a vertical stacking movement.

Aspects of the invention may also be applied to plate and frame devises, such as heat exchangers, and electrochemical cells such as electrolysis cells or fuel cells, membrane filtration devices or other flat sheet membrane based stacks.

The embodiments described above and shown in the Figures are meant to further enable the inventions defined in the following claims but other embodiments may also be made within the scope of the claims.

We is claimed is:

1. (canceled)

2. (canceled)

3. (canceled)

4. (canceled)

5. (canceled)

6. A membrane stack spacer, the spacer comprising:
one or more protrusions outside of a membrane supporting section of the spacer and configured to fit into a corresponding recess of another spacer; and
one or more recesses configured to receive a corresponding protrusion of the other spacer.

7. The spacer of claim 6, wherein each protrusion snap fits into each recess.

8. The spacer of claim 6, wherein the spacer defines two pairs of ports extending through the spacer.

9. The spacer of claim 6, wherein a hole extends from an edge of the spacer to an interior flow field within the spacer.

10. The spacer of claim 6, wherein the spacer has at least one tab defining an alignment hole.

11. The spacer of claim 6, wherein the one or more protrusions and the one or more recesses of the spacer surround the membrane supporting section.

12. The spacer of claim 6, wherein the one or more protrusions comprises a raised perimeter ridge.

13. The spacer of claim 12, wherein
the one or more recesses comprises a raised perimeter U-shaped slot having an inside width on a first surface of the spacer, and
the perimeter ridge is on a second surface of the spacer, aligned with the slot, and has an outside thickness that corresponds with the inside width of the slot.

14. The spacer of claim 6, wherein the membrane supporting section of the spacer comprises diagonal bars configured to support a membrane and one or more spacer lands extending through the thickness of the membrane supporting section.

15. The spacer of claim 6, wherein
the spacer has a flat upper surface, a flat lower surface, and at least one edge surface extending between the upper and lower surfaces,
the one or more recesses are in the upper surface,
the one or more protrusions are in the lower surface, and
the spacer is vertically stackable with the other spacer.

16. The spacer of claim 6, further comprising
the one or more recesses comprises a plurality of spaced holes in the spacer, and
the one or more protrusions comprises a plurality of spaced protrusions on the spacer, each of the plurality of spaced protrusions is aligned with a corresponding one of the plurality of spaced holes.

17. The spacer of claim 16, wherein the spaced holes are circular holes, and the spaced protrusions are cylinders.

18. The spacer of claim 6, wherein the engagement between the spacer and the other spacer is lateral or horizontal.

19. A membrane stack spacer, the spacer comprising:
multiple flexible elements protruding in one direction from a plane of the spacer to contact and seal with another spacer.

20. The spacer of claim 19, wherein the multiple flexible elements protrude in both directions from the plane of the spacer.

21. A membrane stack, comprising:
a first spacer having one or more protrusions outside a first membrane supporting section of the first spacer;
a second spacer having one or more recesses outside a second membrane supporting section of the second spacer, wherein
the one or more protrusions are fit into the one or more recesses of the second spacer to define a chamber between the first and second membrane supporting sections; and
a membrane in the chamber.

22. The stack of claim 21, wherein
the one or more protrusions is a raised perimeter ridge,
the one or more recesses is a raised perimeter U-shaped slot, and
the first and second spacers are vertically stacked with one another when the ridge is fit into the U-shaped slot.

23. The stack of claim 21, wherein
the first and second spacers are flat spacers vertically stacked with one another, each spacer has two pairs of parallel edges, and
the first spacer is rotatable relative to the second spacer in a plane parallel to the first spacer to more than one position in which the edges of the first and second spacers are vertically aligned.

24. A method of making a membrane stack, comprising:
providing a first spacer having a slot;
providing a second spacer having a ridge;
placing a membrane between the first spacer and the second spacer; and
fitting the slot into the ridge to provide a laterally interfering fit between the slot and ridge to vertically stack the first spacer with the second spacer.

25. The method of claim 24, wherein the ridge is snap fit into the slot.
